(19) United States
(12) Patent Application Publication
(10) Pub. No.: US 2003/0210141 A1
(43) Pub. Date: Nov. 13, 2003

(54) Beverage container holder

(76) Inventor: Frank Iacovino, Queen Creek, AZ (US)

Correspondence Address: FRANK IACOVINO, 30732 N. ROYAL OAK WAY, QUEEN CREEK, AZ, 85242, US

(21) Appl. No.: 10/141,287

(22) Filed: May 8, 2002

(51) Int. Cl. G08B 1/08

(52) U.S. Cl. 340/539.1

(57) ABSTRACT

A beverage container holder is provided including a receptacle for receiving a beverage container. The beverage container holder includes a mechanism for selectively producing an output that is at least one of sound, light, and motion. The beverage container holder also includes a wireless remote receiver for receiving wireless signals and selectively controlling the mechanism to produce the output.

### BACKGROUND OF THE INVENTION

1. Field of the Invention

The present invention relates to beverage accessories, and more specifically the present invention relates to beverage container holders.

2. Description of the Related Art

By their very nature, beverages have led the beverage industry to develop a large variety of beverage accessories. The fluid form of beverages requires containment to allow a beverage to be handled. This has led to the development of a variety of short and long term beverage containers and beverage container holders. Beverage container holders have become a common item available in a large variety of configurations. They may be solely for holding a beverage container, or they may also be used to insulate the associated beverage and its beverage container from the outside environment. Examples of beverage container holders include beverage container sleeves, insulators, and cozies. They may simply surround the beverage container or they may provide additional features such as a handle. Although a beverage container holder may not be intentionally designed to insulate a beverage container, they will generally afford some level of insulation simply because they surround some of the beverage container's surfaces. Most beverage container holders are designed to insulate the beverage in the beverage container so it stays warm or cool longer. Another desirable features of beverage container holders include providing an improved surface for an individual to hold or grip a beverage container. Alternately, the beverage container holder may provide a handle for an individual to hold. The beverage container holder allows an individual to hold a beverage container without being exposed to its temperature or any condensate on the beverage container. The beverage container holder isolates any surfaces on which the beverage container may be placed from direct exposure to the beverage container, so the surface will not be damaged by the beverage containers temperature, any condensate on the beverage container, or any sharp or hard surfaces on the beverage container. Beverage container holders have also been used to decorate a beverage container or to provide advertisements or marketing messages directed to the individual using the beverage container holder. Beverage producers may give away beverage container holders to individuals to advertise their products, as previously described.

Beverage container holders have been designed to insulate beverages from the environmental conditions outside the insulating beverage container holder. This allows the beverage and its respective beverage container to be kept at a temperature other than the temperature of the environment outside, or external to the beverage container holder, for longer periods of time than would otherwise be possible without the added insulation. The temperature of the beverage may be higher or lower than the outside temperature. Thus, either cold or hot drinks may be insulated by an insulating beverage container holder.

The primary beverage container held by a beverage container holder is typically a glass or cup, a bottle, or a can. A cozy that can be slipped over a primary beverage container such as a bottle or can is an example of a common insulating beverage container holder. The cozy typically is made of an insulating material such as a foamed polymer. Examples of typical foamed polymers used in prior art insulating beverage container holders include plastics or elastomers. Cozies have also been made of a woven material or fabric that is in the form of a sock that slides over the primary beverage container. A cozy generally surrounds the sidewalls and the base of the primary beverage container, thus providing insulation to these surfaces from the outside environment. U.S. Pat. No. 4,293,015 discloses an insulating beverage container holder that surrounds and insulates the primary beverage container.

Prior art beverage container holders have come in a large variety of shapes and forms. They may or may not be intended to provide insulation to the primary beverage container, as disclosed previously. They may be rigid or flexible. U.S. Pat. No. 6,286,709 discloses a flexible fabric beverage insulator for single beverages.

Prior art beverage container holders have been disclosed with ornamental or novelty features such as decorative designs, advertisements or logo's on the exterior surfaced of the beverage container holder, visual displays such as lights that may be actuated by the user through an integral switch, audible outputs through speakers or other audio transducers that may be actuated by the user through an integral switch, and many other such decorative, novelty, or practical features. U.S. Pat. No. 4,886,183 discloses an insulating beverage container holder including a lighted display and a pressure switch to actuate the display. U.S. Pat. No. 5,152,709 discloses an insulating beverage container holder that may be used as an aerial toy when removed from the beverage container. Some prior art beverage container holders disclosed have included visual displays that may be used to display messages. U.S. Pat. No. 4,886,183 discloses an insulating beverage container holder including a lighted display to illuminate a message on the surface of the insulated beverage container holder. The beverage container holder disclosed includes a switch wired between the battery and the lighted display so the user can turn the display on manually when it is desired to display the message.

Prior art beverage container holders including integral electronically actuated outputs generally include integral mechanically actuated switches such as manual switches or pressure sensitive switches that are used to actuate the output. U.S. Pat. No. 4,886,183 discloses a beverage container holder with an integral lighted display including an integral manual mechanical switch to actuate the display at the user's discretion. U.S. Pat. No. 5,990,790 discloses a base for a beverage container holder that includes an electronically actuated output that produces sound, light, or motion and an integral switch to actuate the output. The integral switch is disclosed to be either a manual switch or a normally open or normally closed pressure sensitive switch that changes state when the base, in conjunction with a beverage container holder, is placed on or removed from a surface. Prior art beverage container holders including integral electronically actuated outputs are limited because they can only be actuated manually by direct contact by an individual.

### OBJECTS OF THE INVENTION

Accordingly, an object of the invention is to provide a beverage container holder for holding beverage containers.

Another object of the invention is to provide a beverage container holder that can be used to insulate beverages.

Another object of the invention is to provide a beverage container holder that can produce an output.

Another object of the invention is to provide a beverage container holder allows for control of the output without direct contact.

Another object of the invention is to provide a beverage container holder allows for control of the output remotely.

### SUMMARY OF THE INVENTION

To achieve the foregoing objects, and in accordance with the purposes of the invention as embodied and broadly described in this document, in accordance with on aspect of the invention a beverage container holder is provided comprising a receptacle for receiving a beverage container. The beverage container holder includes a mechanism for selectively producing an output that is at least one of sound, light, and motion. The beverage container also includes a wireless remote receiver for receiving wireless signals and selectively controlling the mechanism to produce the output.

In the preferred embodiments, the beverage container holder is for use with a beverage container that is a bottle, can, or a glass. The beverage container holder includes a receptacle that preferably comprises an insulator for insulating the beverage container. The receptacle preferably comprises a sleeve and a holder base. The beverage container holder is preferably for use with cold beverages. The receptacle preferably comprises a cozy.

In one of the preferred embodiments of the beverage container holder the mechanism is in the holder base. In another one of the preferred embodiments the mechanism is in the sleeve. The wireless remote receiver preferably is in the sleeve or in the holder base. In one of the presently preferred embodiments of the beverage container holder the mechanism and the wireless remote receiver are both in the holder base. Preferably the mechanism is electronic.

In some of the presently preferred embodiments of the beverage container holder the output is at least one of sound and light. Preferably the wireless remote receiver includes a decoder. Preferably the wireless remote receiver includes an antenna for receiving radio frequency signals. In the preferred embodiments the wireless signals are short distance signals that are radio frequency signals. Preferably the wireless signals are produced by a remote control and the beverage container holder responds to a plurality of remote controls to produce the output. In the preferred embodiments each wireless signal has a signal format and the output has at least one output format. Preferably each output format corresponds to at least one specific signal format. Preferably each output format corresponds to a specific signal format and the beverage container holder responds to wireless signals having the specific signal format to produce output in the at least one output format. In some of the presently preferred embodiments the wireless signals are produced by a remote control in a plurality of signal formats including the at least one specific signal format. In some of the presently preferred embodiments of the beverage container holder the output comprises information and the wireless signals convey the information.

In one of the preferred embodiments of the beverage container holder the receptacle is rigid. In some of the preferred embodiments receptacle is flexible. Preferably the receptacle comprises a sleeve and a holder base, and the holder base in some of the preferred embodiments may be separated from the sleeve. In these preferred embodiments preferably the mechanism is in the holder base. Alternately in these preferred embodiments the wireless remote receiver is in the holder base. More preferably both the mechanism and the wireless remote receiver are in the holder base according to these preferred embodiments.

### BRIEF DESCRIPTION OF THE DRAWINGS

The accompanying drawings, which are incorporated in and constitute a part of the specification, illustrate presently preferred embodiments and methods of the invention and, together with the general description given above and the detailed description of the preferred embodiments and methods given below, serve to explain the principles of the invention.

FIG. 1 is a perspective view of the beverage container holder according to a presently preferred embodiment of the invention;

FIGS. 2A-C depicts preferred beverage containers for use with beverage container holder;

FIG. 3 depicts a generally cylindrical glass beverage container;

FIG. 4 is a cutaway side view of the beverage container holders according to one of the presently preferred embodiments;

FIG. 5 depicts a remote control in use with a beverage container holder according to one of the presently preferred embodiments.

### DETAILED DESCRIPTION OF THE PREFERRED EMBODIMENTS AND METHODS

Reference will now be made in detail to the presently preferred embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in this section in connection with the preferred embodiment and method. The invention according to its various aspects is particularly pointed out and distinctly claimed in the attached claims read in view of this specification, and appropriate equivalents.

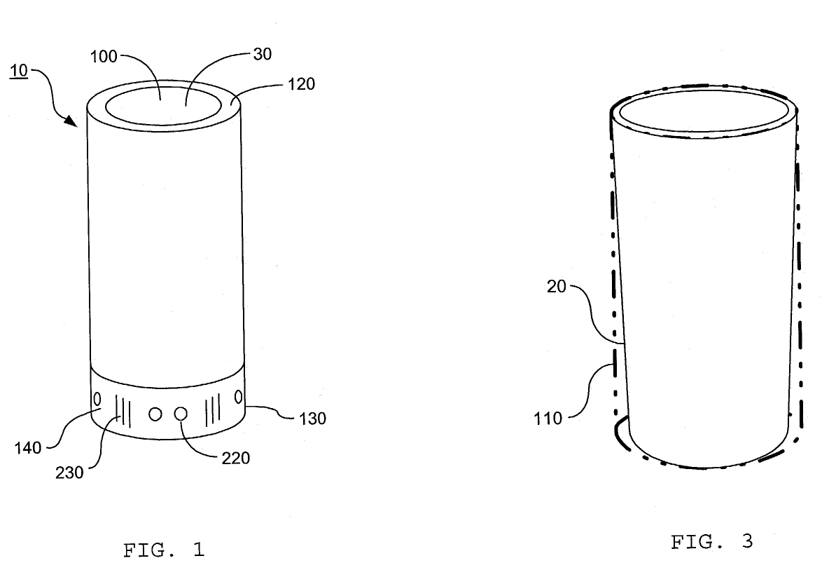

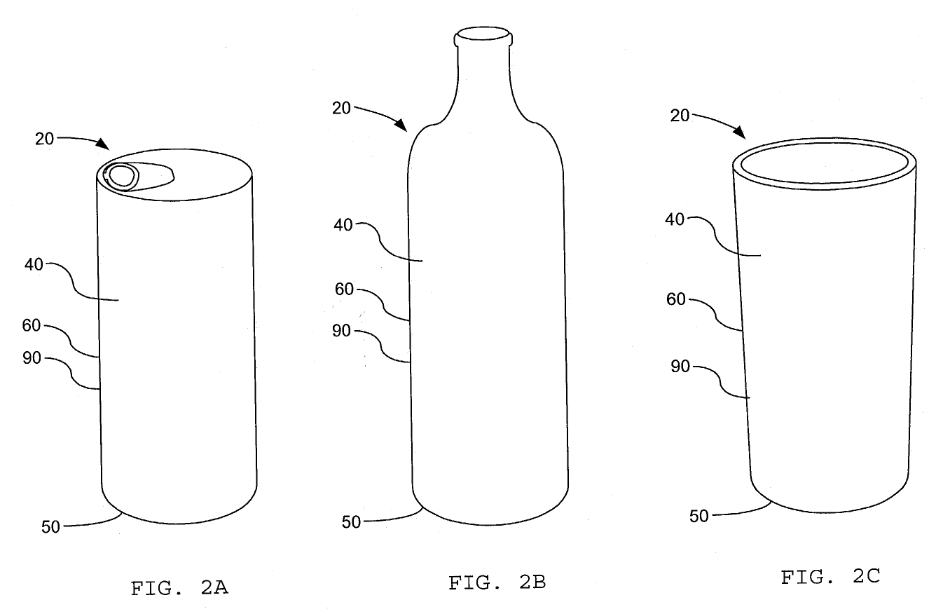

In accordance with one aspect of the invention, a beverage container holder is provided including a receptacle for receiving a beverage container. In the preferred embodiments according to this aspect of the invention a beverage container holder 10 is provided for holding beverage containers 20. The beverage container holder further includes a receptacle 30 for receiving a beverage container, as depicted in FIG. 1. The beverage container holder 10 preferably is for holding any variety of beverage containers including cans, bottles, glasses, cups, mugs, cartons, jars, carafes, pitchers, etc. The beverage container holder 10 of the preferred embodiments is especially useful in holding cans, bottles, and cylindrically shaped glasses. FIGS. 2A, 2B, and 2C depict a beverage container that is a can, a bottle, and a cylindrical glass respectively. The primary container body 40 of these beverage containers 20 is generally cylindrical in shape and does not include a handle. The term generally cylindrical is not intended to be limiting, but is intended to convey a shape that will generally be perceived as being cylindrical in nature by most observers. A geometry that can be bounded by a truly cylindrical shape at its exterior and does not deviate from the bounding cylindrical shape 110 by more than about one quarter of the true bounding cylinder's shape will generally be viewed as cylindrical in nature by most observers. A generally cylindrical beverage container that is a glass is depicted in FIG. 3 with a bounding cylindrical shape 110 that is a true, or perfect cylinder. For example, the diameter or the height of the generally cylindrical shape will not vary from that of the bounding cylindrical shape 110 by more than about one quarter of that of the bounding cylindrical shape. Again, the beverage containers for use with the preferred embodiments of the beverage container holder include a container body 40 that is generally cylindrical, but the beverage container holder according to the invention may be designed to be used with beverage containers of any geometry or size. The beverage container holder 10 may be any size that is useful, but it generally is sized to be used with common beverage containers such as bottles, cans, or glasses. Preferably the beverage container holder 10 is sized to be used with beverage containers of about 1 quart or less in size, and more preferably, the beverage container holder is sized for use with beverage containers from about one half (½) of a pint to about a one and one half (½) pints in size. The container body 40 for the beverage containers 20 for use with the preferred embodiments of the beverage container holder includes a container base 50 and container sidewalls 60. The preferred beverage containers 20 do not include handles. As a result they are less convenient to handle. The beverage consumer generally grips these containers by the container sidewalls 60 when handling this variety of beverage container.

The preferred beverage containers 20 for use with the beverage container holder are generally not well insulated along the container sidewalls 60. The outer sidewall surface 90 of the container sidewalls 60 are generally at or around the temperature of the beverage inside the beverage container 20. As a result, the beverage consumer gripping these beverage containers by the outer sidewall surface 90 is generally exposed to the temperature of the beverage inside the beverage container, as well as any resulting affects to the exterior of the beverage container outer sidewall surface 90, such as condensation if the beverage in the container is cold. The outer sidewall surface 90 of the beverage container may also have a label, as is often used on beverage containers such as bottles. Typical labels used on beverage containers such as bottles often begin to peel off and/or release the bonding adhesive used to bond them to the beverage container when exposed to moisture. Such moisture is often present on these labels due to condensation, or as a result of soaking the beverage container in cool water or ice to keep the beverage container and the beverage inside cool. As a result, the beverage consumer is often exposed to unsightly peeling labels and dissolved, sticky adhesive from these labels when handing the beverage container. Accordingly, the beverage container holder of the preferred embodiments partially or totally covers the otherwise exposed outer sidewall surface 90 so the beverage consumer is not directly exposed this surface when handling the beverage container. Additionally, the beverage container holder of the preferred embodiments covers unsightly container outer sidewall surfaces 90 such as surfaces with peeling labels or undesirable aesthetics.

In the preferred embodiments of the beverage container holder 10, the receptacle 30 of the beverage container holder is for receiving beverage containers by inserting the beverage container into receptacle opening 100. In the preferred embodiments according to this aspect of the invention the receptacle includes a cavity in the beverage container holder 10 that is generally cylindrical in shape and is sized to receive beverage containers 20 with container bodies 40 that are generally cylindrical in shape. The receptacle 30 is sized to provide a relatively snug fit around the beverage container 10 that it is intended to receive. In the preferred embodiments of the beverage container holder, the beverage container holder includes a sleeve 120 as shown in FIG. 1. The inside surface of the sleeve 120 forms the inner sidewalls for the receptacle 30. The term sidewall as used herein refers to any number of sidewalls. It is not intended to be limiting. The receptacle may be of any geometry, and it may include a single sidewall, such as is the case with a cylindrical geometry with a circular cross section. Alternately, it may contain a number of sidewalls, as is the case with a non-cylindrical geometry with a cross section such as a polygon. In the latter case, the number of sidewalls is equal to the number of sides on the polygonal cross section. The shape of the receptacle is preferably selected to fit the beverage containers that the beverage container holder is designed to hold.

In the preferred embodiments of the invention, the receptacle is flexible and the sleeve 120 is formed from pliable material such as foamed elastomer or fabric so the sleeve can expand in diameter to fit around the main container body 40 of the beverage container 20. The flexible sleeve allows the receptacle to conform to the beverage containers placed in the receptacle. In the preferred embodiments, the sleeve is sufficiently flexible to deform sufficiently to conform around the beverage containers intended to be used with the beverage container holder, but it may retain sufficient rigidity to keep its generally cylindrical form or shape when it is not being used with a beverage container. The base in the preferred embodiments may be rigid, semi-rigid, or flexible as discussed in more detail in the following. The use of a flexible sleeve to create a flexible receptacle allows the beverage container holder to be used with a range of beverage containers 20 while still providing a tight fit around the beverage containers held in the beverage container holder. This is desirable for a variety of reasons, including allowing the beverage container holder 10 to grip the beverage container 20 so it does not slip out of the beverage container holder. It also provides a seal between the exterior surface of the container body 40 of the beverage container 20 and the beverage container holder. This is advantageous if the beverage container holder is also an insulator for thermally insulating the beverage container because this does not allow convective air to flow around the exterior walls of the beverage container, thus insulating it from the outside environment more thoroughly. Alternately, the receptacle 30 can be formed from a rigid or semi-rigid sleeve and holder base resulting in a rigid receptacle.

In the preferred embodiments the receptacle 30 of the beverage container holder 10 includes a cavity formed between the sleeve 120 and the holder base 130 of the beverage container holder, as depicted in FIG. 1. The holder base 130 provides the end of the receptacle 30 as well as the base of the beverage container holder. The holder base 130 provides the inside surface to contact the base 50 of the beverage container 20. The holder base 130 also provides the lower exterior surface of the beverage container holder that is used to support the beverage container holder when it is set on a surface such as a table. The holder base 130 preferably also provides a volume for incorporation of electronics, as will be discussed in more detail in the following. The beverage container holder of the preferred embodiments is formed from sleeve 120 and holder base 130. These two elements of the beverage container holder form the receptacle 30 that is used to hold the beverage containers, allowing the beverage container holder user to insert a beverage container 20 into the beverage container holder 10 and subsequently handle the beverage container by holding the beverage container holder. The holder base and sleeve are attached to form the beverage container holder, but the holder base 130 and the sleeve 120 are not necessarily permanently attached. The holder base 130 may have a quick connect for the sleeve 120 allowing the holder base to be removed from the sleeve at the users discretion. This way, different sleeves 120 may be used with different holder bases 130 to provide for different combinations of holder base and sleeve designs, as will be discussed in more detail in the following. The form of quick connection used between the holder base 130 and sleeve 120 may be any form of quick connection, such as press or snap fits, temporary adhesives, magnets, screw joints, etc. Alternately, the sleeve 120 and the holder base 130 may be permanently or semi-permanently attached. In this alternate case, the beverage container holder user cannot easily mate different sleeves with different holder bases. In the preferred embodiments of the beverage container holder including a quick connection between the holder base 130 and the sleeve 120, the sleeve may or may not include a closed lower end at the bottom of the sleeve where it mates with the holder base. That is to say, the sleeve end that mates with the holder base 130 may or may not be an open end. Either configuration may be used with the quick connection between the sleeve and the holder base.

In the preferred embodiments of the beverage container holder 10, the sleeve 120 and the holder base 130 afford the beverage container some degree of insulation from the outside environment, thus keeping the beverage in the beverage container cool or warm longer. In these preferred embodiments, the sleeve 120 and holder base 130 form a receptacle that is an insulator for the beverage container held by the beverage container holder 10. This is accomplished by manufacturing the sleeve and the holder base from insulating materials. Any material that provides insulating characteristics may be used, but the preferred materials for use with the sleeve 120 are foamed polymeric materials such as foamed plastics and elastomers, or fabrics such as natural or synthetic textiles. The sleeve 120 is preferably made of a flexible material that will allow the sleeve to conform to the exterior surface of the beverage container 20 when it is placed in the receptacle 30 of the beverage container holder 10. The holder base 130 in the preferred embodiments is preferably made from a rigid or semi-rigid material. The base may be made from foamed polymeric materials similar to the sleeve, but the base in the preferred embodiments includes a cavity for mounting the mechanism 140 and the remote wireless receiver 160, as will be described in more detail in the following. The cavity in the holder base provides an air pocket, resulting in increased insulating properties for the holder base. As a result, the holder base 130 in the preferred embodiments provides adequate insulating properties without construction from insulating materials such as foamed polymeric materials. The preferred materials for construction of the holder base are rigid or semi-rigid polymeric materials such as plastics. In the preferred embodiments of the beverage container holder, the sleeve 120 and the holder base 130 form an insulating receptacle 30 that is a cozy. The beverage container holder is preferably for use with cold beverages contained in beverage containers such as cans, bottles, and generally cylindrical glasses, as discussed previously.

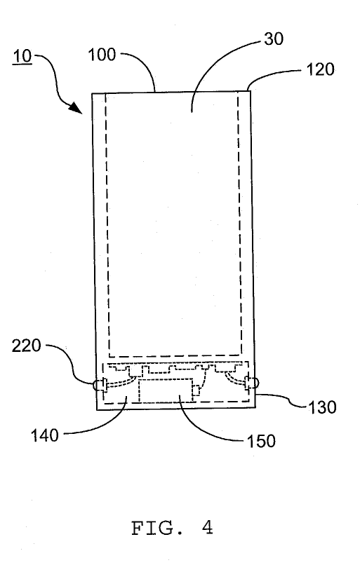

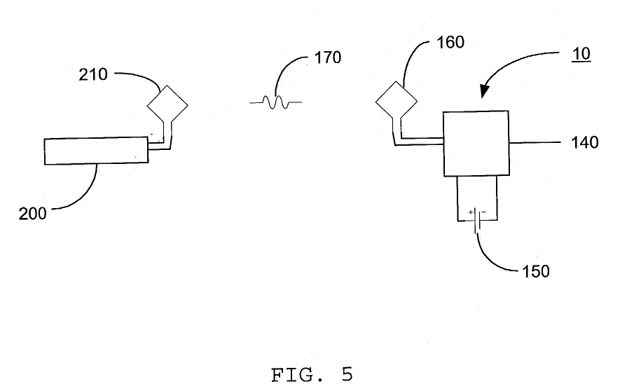

Further in accordance with this aspect of the invention, the beverage container holder includes a mechanism for selectively producing an output that is at least one of sound, light, and motion. In the preferred embodiments according to this aspect of the invention, the beverage container holder 10 includes a mechanism 140, as depicted in FIGS. 1 and 4. The mechanism is for selectively producing output that is sound, light, or motion, or any combination thereof. In the preferred embodiments the mechanism 140 is an electronic assembly including, for example, elements such as a circuit board lights, audio transducers, motion devices such as vibrators, interconnections such as wiring, etc. The preferred embodiments of the beverage container holder 10 may include any combination of sound, light or motion transducers to produce the output. The sound, light, and motion transducers may be any form of transducer that produces the respective output of sound, light, or motion. In the preferred embodiments according to this aspect of the invention, the sound transducers are speakers such as piezoelectric crystals or cone speakers; the light transducers are light bulbs, light emitting diodes, or liquid crystal displays; and the motion transducers are electromechanical vibrators such as the electromagnetic vibrators used in pagers and the like.

In the preferred embodiments, the mechanism 140 includes the necessary circuitry to drive the transducers that create the output. In the preferred embodiments of the invention, the mechanism may include integrated circuits, discrete electronic components, or a combination of both. The mechanism 140 preferably includes provisions for a power source 150 such as a battery, which may or may not be rechargeable. The power source 150 preferably provides the power to operate the mechanism and power the transducers that produce the output. The power source may be any form of power source that can operate the mechanism and power the output, for example solar cells, fuel cells, direct input power such as a power cord, mechanical power such as a spring, or any other source of power to operate the mechanism and power the output transducers, but in the preferred embodiments the power source is one or more batteries. The beverage container holder 10 preferably includes a power switch to activate the mechanism 140 and the wireless remote receiver, as will be discussed in more detail in the following. This allows the user activate the mechanism when it is desired to use the beverage container holder to produce the output, but to deactivate the mechanism when it is not desired to use the beverage container holder to produce the output. This allows the user to selectively actuate or de-actuate the output as desired, as well as to conserve power so the power source does not have to be recharged or replaced as often. In the preferred embodiments the power switch is a manual electrical switch installed between the power source 150 and the beverage container holder electronics including the mechanism 140 and the wireless remote receiver 160, so when the switch is not closed the power source is not connected to the electronics. Alternately, any form of switch may be used to perform the function of the power switch. For example, the power switch may be soft switch such as a logic switch or software switch that provides the mechanism with the necessary instructions not to actuate. The power switch simply needs to provide the user with the ability to actuate and de-actuate the beverage container electronics so the output can selectively be activated or deactivated at the user's discretion.

The mechanism 140 may be located anywhere in the beverage container holder. The mechanism preferably is mounted in the holder base 130, although it may be located in the sleeve or distributed between the holder base 130 and the sleeve 120. The power source 150 in the preferred embodiments may be located either in the sleeve or the holder base. The mechanism 140 in the preferred embodiments having detachable holder bases is preferably contained in the holder base 130. This way the mechanism may easily be changed from one sleeve 120 to another by detaching the holder base 130 and replacing it with another holder base with a different mechanism. This allows users to match different holder bases to different sleeves, creating their own custom combination of holder base and sleeve. Thus, holder bases 130 with different outputs may be mated to different sleeves 120. For example, if the beverage container holder 10 has a sleeve 120 that does not fit the beverage container 20 that the user intends to place in the beverage container holder, the user can replace the sleeve with a sleeve of the correct size for the beverage container to be held in the beverage container holder. Alternately, the holder base 130 may be removed from the sleeve 120 to be used independently of the sleeve at the user's discretion, for example, as a coaster for use with the beverage container. This provides the user with a greater degree of flexibility, thus making the beverage container holder 10 more appealing to end users of the beverage container holder.

Further in accordance with this aspect of the invention, the beverage container holder includes a wireless remote receiver for receiving wireless signals and selectively controlling the mechanism to produce the output. In the preferred embodiments of the beverage container holder 10, the beverage container holder includes a wireless remote receiver 160 for receiving wireless signals 170 and selectively controlling the mechanism 140 to produce the output, as shown in FIG. 5. The wireless remote receiver 160 is preferably electrically coupled to the mechanism 140 to allow the receiver 160 to control the mechanism. The wireless signals 170 may be any form of wireless signals for remotely controlling the mechanism to produce the output. For example, the wireless signals 170 may be radio frequency signals, optical signals such as infra-red signals, audio signals such as sound waves, etc. Any wireless signal may be used, but the preferred wireless signal type is a short distance radio frequency signal. The preferred short distance radio frequency signal is preferably able to be received by the receiver 160 and actuate the mechanism 140 to produce the output over distances of about 500 yards or less, and more preferably over distances of about 100 yards or less. This allows the user to actuate the mechanism to produce the output over short distances with a remote control 200 that produces the proper short distance wireless signal 170, as will be discussed in more detail in the following. As with the mechanism 140, in the preferred embodiments of the beverage container holder with a detachable holder base 130 the wireless remote receiver is preferably located in the holder base. This allows a holder use to change the electronics between beverage container holders by removing the holder base from one beverage container holder and attaching it to another beverage container holder. Alternately, the holder base 130 may be removed from a beverage container holder 10 and used separately as a coaster with all the electronics including the mechanism 140 and the wireless remote receiver 160 intact, as will be discussed in more detail in the following.

FIG. 5 depicts a presently preferred embodiment of the beverage container holder 10 and a remote control 200 transmitting a wireless signal 170 to control the mechanism 140 to produce the output. The remote control includes a remote transmitter 210 for transmitting the wireless signals to the beverage container holder. Preferably the wireless signals are short distance wireless radio frequency signals, and the wireless remote receiver 160 preferably includes an antenna for receiving the radio frequency signals transmitted by the remote control 200. The remote control 200 may take on any configuration. It may be a small portable design similar to those used for remote car alarms, for example, as small as about 1 or 2 inches on the its largest dimension. This variety of remote control design is well known in the remote control industry. It is used for car alarms, remote car actuators such as remote car starters, garage or community gate opener systems, etc. This variety of remote control generally has a limited number of actuation switches on the remote control to actuate the system it is intended to work with. The size of this variety of remote control is too small to provide for a large number of different actuation switches. This very small sized remote control allows the remote to be attached, for example, to the remote control user's key chain without becoming cumbersome to handle. In this case the remote control 200 only has room for a few actuation switches, as discussed previously. The remote control 200 for use with the preferred embodiments of the beverage container holder 10 preferably includes at least one manual actuation mechanism for actuating the remote control to produce the short distance wireless signal 170. The preferred manual actuation mechanisms are manual switches. For the smaller remote control designs, the manual actuation mechanism is one or more push button switches. When a user pushes the push button switch, the remote control sends the wireless signal 170 to prompt the mechanism 140 in the beverage container holder 10 to produce the output, which may be any one of sound, light, or motion or any combination thereof.

Generally, each of the smaller “key chain” sized remote controls are intended to be used with one beverage container holder. As is well known in the field of remote control systems, the wireless signals produced by the remote control are encoded and have a signal format. The signal format makes a particular wireless signal specific, much like a word or phrase as they are used in language. The mechanism 140 in the beverage container holder is configured to respond only to wireless signals 170 with one or more specific signal formats. If a wireless signal 170 is received by the wireless remote receiver 160 that does not have the correct signal format, the mechanism 140 does not respond to produce the output. The mechanism 140 in conjunction with the wireless remote receiver 160 may only respond to wireless signals with one specific signal format and produce only one output, which may be any one of sound light or motion or any specific combination thereof. Alternately, the mechanism may respond to more than one signal format to produce the output. A mechanism 140 that produces output in response to wireless signals received by the wireless remote receiver 160 with more than one signal format may produce different output formats for each different signal format to which the mechanism responds, or it may produce the same output format for each of the various signal formats recognized. The output has an output format which is a unique combination of characteristics such as duration, intensity, modulation, color (for light), frequency (for sound and motion), etc. The output format of the output produced by the mechanism 140 may be different for each different signal format of the wireless signals received by the receiver 160. Alternately, the output format for the output produced by the mechanism may be the same for different wireless signals 170 having different signal formats that are recognized by the beverage container holder. For example, a beverage container holder 10 may have a mechanism 140 and receiver 160 that recognize 3 different signal formats of wireless signal 170, designated signal format 1, signal format 2, and signal format 3 for exemplary purposes. In response to signal format 1, the mechanism of the example may produce an output that is light of a specific output format (time duration, color, intensity, modulation, etc.). In response to signal format 2, the mechanism of the example may produce an output that is a combination of light and sound of a different output format. In response to signal format 3, the mechanism of the example may produce an output that is sound of yet another different output format. Alternately, the mechanism may produce the same output format, for example light of a specific output format, for all three signal formats of wireless signals. Any combination of recognized wireless signal format to corresponding output format is permissible. Generally, the smaller “key chain” variety of remote controls will only produce a limited number wireless signals 170 with different wireless signal formats.

Alternately, the remote control 200 may be larger in size, for example it may be similar to a remote control for a TV, including a number of actuation mechanisms such as push button switches. Alternately, it may be a desk top or counter top variety of design. It may be computerized so that the wireless signals 170 it produces are computer controlled. The mechanism 140 and wireless remote receiver 160 in the beverage container holder 10 may include logic allowing it to derive instructions from the wireless signal of the recognized signal format. For example, the beverage container holder 10 may include a mechanism 140 that has a visual display such as a light emitting diode or a liquid crystal display that can create visual images. The wireless signal may be encoded to include the necessary information to instruct the mechanism to display specific visual images on the display. These visual images may be words or phrases, which may be useful in advertising products or services. Alternately, they may be pictures or other forms of abstract images. This may be useful for advertising, or it may be used to produce aesthetically pleasing images for entertainment or novelty purposes. As the term is used herein, a light output is intended to mean any form of output that is visually recognized by individuals looking at the beverage container holder. A beverage container holder producing a light output may actually produce the light through the use of light producing devices such as light bulbs or light emitting diodes, or it may use reflected light to change an individual's perception of the light emanating from the beverage container holder. A liquid crystal display or LCD is an example of the latter form of devices—devices that produce an output that is light by changing the intensity and color (or frequency content) of the light reflected from the device, thus changing an individual's perception of the device's appearance. Whether the mechanism 140 actually generates the light or whether it uses the ambient light and modifies the way it is reflected does not matter. Both varieties of mechanism produce an output that is light as the term is used herein.

The preferred embodiments utilizing larger remote controls can support a larger, more complex variety of wireless signals, making them useful for controlling more than one beverage container holder. The beverage container holder 10 may be used with only a single discrete remote control 200, or it may be used with more than one remote control. Additionally, a remote control 200 may be used with more than one beverage container holder. The beverage container holder 10 simply receives wireless signals and produces output of one or more output formats. The source of the wireless signals does not matter, any number and combination of wireless signal sources may be used with the beverage container holder. Remote control systems that produce wireless signals 170 for use with a variety of beverage container holders 10 may be particularly useful with large groups of people, for example at restaurants and bars. According to another one of the preferred embodiments of the beverage container holder 10, the output comprises information and the wireless signals 170 transmit the information. According to this embodiment, the beverage container holders 10 may be used to convey information to the user of the holder, for example, it may produce advertisements or other marketing information to assist the establishment using the beverage container holders to promote products or services. Alternately, the beverage container holder 10 may convey information to the holder user. The information may be news, such as sports scores or stock tickers, or the information may be specific to the holder user such as a page to inform the user that their reservation for dinner is set and the establishment is now ready to seat them. A discrete remote control 200 may be used in a system with more than one beverage container holder 10, as discussed previously. In this case, if the information sent to the beverage container holder through the wireless signal 170 is specific to one or a limited number of the beverage container holders in the system, the remote control preferably produces a plurality of different wireless signals with different signal formats. The different signal formats allow the remote control to communicate with different beverage container holders or different groups of beverage container holders within the total set of beverage container holders within the system. The discrete beverage container holders recognize a subset of specific signal formats included in the plurality of signal formats produced by the remote control. In the case of a paging system for paging individuals in a group at an establishment, each beverage container holder may only respond to one specific wireless signal format. The remote control produces a plurality of different signal formats, including all of the signal formats recognized by the entire set of beverage container holders in the paging system.

The beverage container holder 10 may include additional features, such as switches, to allow the user to select different output formats to be produced by the holder when a recognized wireless signal is received. For example, a manual switch that allows the user to change the output from a light signal to a sound signal, or the format of the output signal from one modulation to another. One output format may include LED's blinking to one pattern, and another may change the pattern of the blinking. Alternately, the beverage container holder 10 may include switches that allow the holder user to select the signal format recognized by the beverage container holder between different wireless signal formats that are being transmitted at an establishment. For example, the beverage container holder may include a mechanism that decodes information from wireless signals 170 of the recognized signal format and displays the information, such as text information, on the mechanism's display. In this embodiment of the beverage container holder 10, the output includes information and the wireless signals 170 convey the information. The switches may allow the holder user to select between signal formats containing different varieties of information, ie: the holder user may change the signal format recognized from one that transmits a stock ticker on the display of the mechanism 140 to one that transmits sports scores. In this example, the beverage container holder 10 includes a mechanism 140 and wireless remote receiver that recognize wireless signals 170 of different signal formats carrying different information on each of the different signal formats. The signal formats essentially act as channels of information, and the switch allows the user to select different information channels. The signals formats may include any combination of sound, light, or motion. The wireless signals 170 in the preferred embodiments are preferably short distance wireless signals, as described previously.

The mechanism 140 and receiver 160 preferably include the necessary electronic hardware and software to receive the wireless signals 170 and recognize the format of the wireless signals to determine if they are of the specific format required to prompt the mechanism 140 to produce output. The recognition of the signal format of the wireless signal can be performed by the receiver 160, the mechanism 140, or the task may be distributed between both the receiver and the mechanism. The architecture doesn't matter. Any electronic system including a mechanism and a receiver that performs the task of receiving the wireless remote signals and recognizing the signal format of these signals to determine the appropriate response by the beverage container holder is within the scope of the invention as disclosed herein. Preferably the wireless signals are radio frequency signals and the receiver includes an antenna and the electronics necessary to analyze signals received at the antenna and provide commands to the mechanism to produce the output when the appropriate input wireless signal is received. A large variety of electronic and software configurations could be used to perform these functions, as is well recognized in the art. Preferred electronic circuitry for the receiver may include discrete circuit components, integrated circuits, microprocessors or micro-controllers, or any other form of electronic components that may be used to accomplish the task of receiving the wireless signal and decoding it to determine the appropriate response for the beverage container holder. For example, many manufacturers make integrated circuits for use in short distance radio frequency transmitter and receiver systems that include the necessary electronics to transmit encoded signals from a remote control and recognize and receive those signals at a receiver to actuate the device associated with the receiver. These transmitter/receiver integrated circuit pairs are for use in short distance wireless applications such as car alarms, garage door openers, gate openers, home security systems, and a variety of other applications.

The Keeloq® family of radio frequency encoders/decoders manufactured by Microchip Corporation of Chandler, Ariz. are one of the presently preferred families of receiver/transmitter integrated circuit systems for use in the beverage container holder. This family of encoders and decoders is for use in a large variety of short distance radio frequency control systems. The encoders are for use in the remote control and the decoders are for use in the receiver, for example in the receiver 160 of the beverage container holder. The Keeloq® family of radio frequency encoders and decoders allow the wireless signal 170 to be encoded so that the signal is not easily captured and copied, providing a great deal of security in the wireless signal transmission. This also minimizes the possibility of inadvertent actuation of the beverage container holder by spurious wireless signals. The Keeloq® family of decoders may be used stand alone in the receiver or they may be used in conjunction with a microcontroller. The use of a microcontroller with the decoder provides for the recognition of more sophisticated combinations of signal formats for the wireless signals 170. This allows the beverage container holder to provide more output formats with greater complexity, as the transmitter/receiver system is capable of communicating more sophisticated commands to the beverage container holder when a micro-controller is used in concert with the Keeloq® decoders.

A prototype beverage container holder according to one of the presently preferred embodiments of the invention was constructed from a standard beverage cozy and a wireless luggage locator. The wireless luggage locator was obtained from LuggageLocator.com Inc. of Miami Fla. The luggage locator includes a transmitter and a receiver. The transmitter is a small wireless transmitter that may be mounted to a key chain. It includes a battery and a circuit board assembly with the necessary electronics to transmit a wireless signal that actuates the receiver. The luggage locator system is specified to work over a range of up to 50 meters. The receiver is a small unit that is intended to be mounted or attached to a piece of luggage that may require locating. The receiver includes the necessary electronics to receive the wireless signal from the transmitter and respond by producing an audio and a visual output (beeping and blinking according to the literature provided with the luggage locator). The audio and visual ouputs are produced by a small speaker and a light emitting diode both located on the receiver. When the transmitter is actuated to produce the wireless signal by depressing the actuation button on the transmitter, the receiver produces the audio and visual output so the user may find their luggage.

To create the prototype beverage container holder, the receiver of the luggage locator was dissected to extract the circuit board assembly including the light emitting diode and the speaker, as well as the associated battery interface wiring. The beverage cozy was modified to include a plastic base that had a cavity to mount the receiver circuit board assembly obtained from the luggage locator. The circuit board assembly and battery, when mounted in the cavity located in the base of the cozy, had a cross section similar to the beverage container holder depicted in FIG. 4. Multiple light emitting diodes 220 were wired in parallel with the light emitting diode already provided with the luggage locator's receiver. This way the prototype beverage container holder had a plurality of lights in the base. These light emitting diodes 220 were mounted in groups in the base of the beverage container holder at 90 degree increments, similar to that shown in FIGS. 1 and 4. Slots 230 were cut in the base of the cozy in between the groups of lights. These slots allow the audio output from the speaker located on the luggage locator's receiver circuit board assembly to escape from inside the cavity so the audio output can be heard. The slots are depicted in FIG. 1.

The prototype beverage container holder was tested by depressing the button on the transmitter while the transmitter was located several meters from the beverage container holder. The light emitting diodes in the base of the beverage container holder blinked on and off for several seconds while the beverage container holder produced a beeping sound. The transmitter was moved to about 10 meters from the beverage container holder and the actuation button was depressed. The beverage container holder again responded by blinking the light emitting diodes and beeping for several seconds. The transmitter was moved to about 30 meters from the beverage container holder and the procedure was repeated. The beverage container holder again responded by blinking and beeping for several seconds.

Additional advantages and modifications will readily occur to those skilled in the art. Therefore, the invention in its broader aspects is not limited to the specific details, representative devices and methods, and illustrative examples shown and described. Accordingly, departures may be made from such details without departing from the spirit or scope of the general inventive concept as defined by the appended claims and their equivalents.

What is claimed is:

1. A beverage container holder comprising:
a receptacle for receiving a beverage container;
a mechanism for selectively producing an output that is at least one of sound, light, and motion;
and a wireless remote receiver for receiving wireless signals and selectively controlling the mechanism to produce the output.

2. The beverage container holder of claim 1, wherein the beverage container is a bottle, can, or a glass.

3. The beverage container holder of claim 1, wherein the receptacle comprises an insulator for insulating the beverage container.

4. The beverage container holder of claim 3, wherein the receptacle comprises a sleeve and a holder base.

5. The beverage container holder of claim 3, wherein the beverage container holder is for use with cold beverages.

6. The beverage container holder of claim 3, wherein the receptacle comprises a cozy.

7. The beverage container holder of claim 4, wherein the mechanism is in the holder base.

8. The beverage container holder of claim 4, wherein the mechanism is in the sleeve.

9. The beverage container holder of claim 4, wherein the wireless remote receiver is in the sleeve.

10. The beverage container holder of claim 4, wherein the wireless remote receiver is in the holder base.

11. The beverage container holder of claim 7, wherein the wireless remote receiver is in the holder base.

12. The beverage container holder of claim 1, wherein the mechanism is electronic.

13. The beverage container holder of claim 1, wherein the output is at least one of sound and light.

14. The beverage container holder of claim 1, wherein the wireless remote receiver includes a decoder.

15. The beverage container holder of claim 1, wherein the wireless remote receiver includes an antenna for receiving radio frequency signals.

16. The beverage container holder of claim 1, wherein the wireless signals are short distance signals.

17. The beverage container holder of claim 1, wherein the wireless signals are radio frequency signals.

18. The beverage container holder of claim 1, wherein the wireless signals are produced by a remote control and the beverage container holder responds to a plurality of remote controls to produce the output.

19. The beverage container holder of claim 1, wherein each wireless signal has a signal format and the output has at least one output format.

20. The beverage container holder of claim 19, wherein each output format corresponds to at least one specific signal format.

21. The beverage container holder of claim 19, wherein each output format corresponds to a specific signal format and the beverage container holder responds to wireless signals having the specific signal format to produce output in the at least one output format.

22. The beverage container holder of claim 20, wherein the wireless signals are produced by a remote control in a plurality of signal formats including the at least one specific signal format.

23. The beverage container holder of claim 1, wherein the output comprises information and the wireless signals convey the information.

24. The beverage container holder of claim 1, wherein the receptacle is rigid.

25. The beverage container holder of claim 1, wherein the receptacle is flexible.

26. The beverage container holder of claim 1, wherein the receptacle comprises a sleeve and a holder base, and the holder base may be separated from the sleeve.

27. The beverage container holder of claim 26, wherein the mechanism is in the holder base.

28. The beverage container holder of claim 26, wherein the wireless remote receiver is in the holder base.

29. The beverage container holder of claim 28, wherein the mechanism is in the holder base.
